(19) United States
(12) Patent Application Publication
(10) Pub. No.: US 2016/0009064 A1
(43) Pub. Date: Jan. 14, 2016

(54) METHOD FOR ACTIVATING ADHESIVES ON COMPLEX SURFACES

(71) Applicant: Apple Inc., Cupertino, CA (US)

(72) Inventors: Jeremy C. Franklin, San Francisco, CA (US); Justin Richard Wodrich, Saratoga, CA (US); Yoji Hamada, Wakayama (JP)

(21) Appl. No.: 14/328,600

(22) Filed: Jul. 10, 2014

Related U.S. Application Data
(63) Continuation of application No. PCT/US14/46212, filed on Jul. 10, 2014.

(51) Int. Cl. B32B 37/10

(52) U.S. Cl. CPC B32B 37/1009; B32B 2309/12

(57) ABSTRACT

An expandable member configured to inflate and actuate a first element toward a second element in order to adhesively attach the first element with the second element is disclosed. The expandable member is made of a material (or materials) having a low tensile strength and flexural modulus such that the expandable member may conform to complex, or non-linear shapes. Also, the expandable member provides a sufficient force to the first element such that the first element applies at least a minimum threshold pressure to the adhesive layer in order to activate the adhesive layer. In some embodiments, the expandable members are used to actuate the first element. The described embodiments may be used to adhesively attach external or internal components of an electronic device.

### CROSS-REFERENCE TO RELATED APPLICATION

This is a continuation of International Application No. PCT/US14/46212 filed Jul. 10, 2014, entitled “Method For Activating Adhesives On Complex Surfaces,” which is incorporated herein by reference in its entirety.

### FIELD

The described embodiments relate generally to adhesively assembling parts. In particular, the present embodiments relate to applying a uniform pressure across a non-stiff structure.

### BACKGROUND

An electronic device (e.g., smartphone, tablet computing device) may include a cover glass (“CG”) adhesively attached with an enclosure. In some cases, the CG and enclosure are bonded using a pressure sensitive adhesive (“PSA”) which activates (or bonds two structures) when pressure is applied to the PSA. In order to properly activate a PSA layer, all portions of the PSA layer should receive at least a minimum threshold pressure. One approach is to employ a linear rigid fixture to engage a surface of the CG. The PSA may be applied to a surface of the enclosure. When the rigid fixture engages the CG and actuates the CG toward the enclosure, the CG engages and applies pressure to the PSA.

However, the rigid fixture has several drawbacks. For example, if the CG and/or the enclosure are not perfectly aligned with each other, the rigid fixture may cause the CG to apply an overpressure to some portions of the PSA while leaving other portions of the PSA with no pressure, or pressure below the minimum threshold pressure. As a result, the CG may not be sufficiently bonded to the enclosure. Further, in cases where elements to be adhesively attached include a surface having complex or non-linear portion, the rigid fixture may not apply a uniform force to one of the elements resulting in similar issues of insufficient pressure to the PSA. This is problematic, particularly during a drop event of the electronic device because the CG may delaminate or become de-bonded from the enclosure. Attempts to modify the rigid fixture by partitioning the rigid fixture into four smaller rigid fixtures cause still results in overpressure and insufficient pressure in the four respective regions. Additional tolerance adjustments are typically necessary resulting in increased manufacturing time.

### SUMMARY

In one aspect, a method for adhesively attaching a first element with a second element is described. The method may include expanding an expandable member in a first direction such that the expandable member engages the first element. The method may further include actuating the first element in the first direction. The method may further include engaging the first element with an adhesive layer. The adhesive layer may be positioned on the second element.

In another aspect, a system for actuating a first element proximate to a second element in order to adhesively attach the first element with the second element is described. The system may include a plate having a cavity. The system may further include an expandable member positioned within a portion of the cavity. In some embodiments, the expandable member capable of expanding from first size to a second size when the expandable member extends in a direction away from the plate when expanding from the first size to the second size. In some embodiments, an adhesive layer bonds with the first element and the second element when the expandable member inflates to the second size.

In another aspect, a method for adhesively attaching a first element with a second element, the first element and the second element part of an electronic device is described. The method may include positioning an expandable member proximate to the first element, the expandable member having a first size. The method may further include expanding the expandable member from the first size to a second size. In some embodiments, while the expandable member is extending to the second size, the expandable member engages the first element and actuates the first element in a direction toward the second element. The method may further include positioning an adhesive layer within the second element. The method may further include engaging the first element with the adhesive layer positioned between the first element and the second element.

Other systems, methods, features and advantages of the embodiments will be, or will become, apparent to one of ordinary skill in the art upon examination of the following figures and detailed description. It is intended that all such additional systems, methods, features and advantages be included within this description and this summary, be within the scope of the embodiments, and be protected by the following claims.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates an embodiment of an electronic device having a first element adhesively attached with a second element;

FIGS. 2 and 3 illustrate cross-sectional views an embodiment of an expandable member used to adhesively attach a first element with a second element;

FIG. 4 illustrates an exploded view showing a plate and an expandable member used to adhesively attach a first element with a second element, in accordance with the described embodiments;

FIGS. 5 and 6 illustrate cross-sectional views of an embodiment of an expandable member used to adhesively attach a first element having a non-linear portion with a second element;

FIGS. 7 and 8 illustrate cross-sectional views of an embodiment of an expandable member used to adhesively attach a first element with second element as well as a third element positioned below the second element;

FIGS. 9 and 10 illustrate a bottom view of an embodiment of plate having several expandable members which may be used to selectively apply different pressures through individual expandable members;

FIGS. 11 and 12 illustrate a cross-sectional an embodiment of an expandable member engaging an elastic member configured to engage a first element in order to adhesively attach a first element with a second element;

FIG. 13 illustrates an isometric view of a portion of an expandable member and first element used to calculate a force applied by an expandable member on a first element;

FIGS. 14 and 15 illustrate embodiments of an assembly process using a first expandable member positioned on a first element and a second expandable member positioned on a second element;

FIG. 16 illustrates a flowchart describing a method for adhesively attaching a first element with a second element; and

FIG. 17 illustrates a flowchart describing a method for adhesively attaching a first element with a second element, the first element and the second element part of an electronic device.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present invention described herein.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting such that other embodiments may be used, and changes may be made without departing from the spirit and scope of the described embodiments.

The following disclosure relates to pressurizing an expandable member in order to actuate a first element toward a second element, and subsequently adhesively attach the first element with the second element. When pressurized, the expandable member may expand or inflate from a first size to a second size larger than the first size. The expandable member is made of a relatively non-stiff material (or materials) such that, during expansion, the expandable member conforms to the shape of the first element. This includes a first element having a complex or non-linear surface. An adhesive layer (for example, pressure sensitive adhesive or PSA) may be positioned between the first element and the second element. The expandable member is configured to apply at least a minimum threshold pressure to the adhesive layer, via the first element, in order to activate the adhesive layer.

In the above example, by conforming to the shape of the first element, the expandable member applies a uniform pressure to the first element in portions where the expandable member engages the first element. In this manner, the entire adhesive layer receives the minimum threshold pressure allowing the entire adhesive layer to activate. Traditional methods involving rigid or stiff fixtures are generally unable to consistently apply a uniform pressure to the first element, particularly when the first element includes a non-linear or complex surface. As a result, not all portions of the PSA activate and elements are not adhesively attached in a desired manner. Alternatively, the rigid fixture several iterations of pressing against the first element which increases manufacturing times.

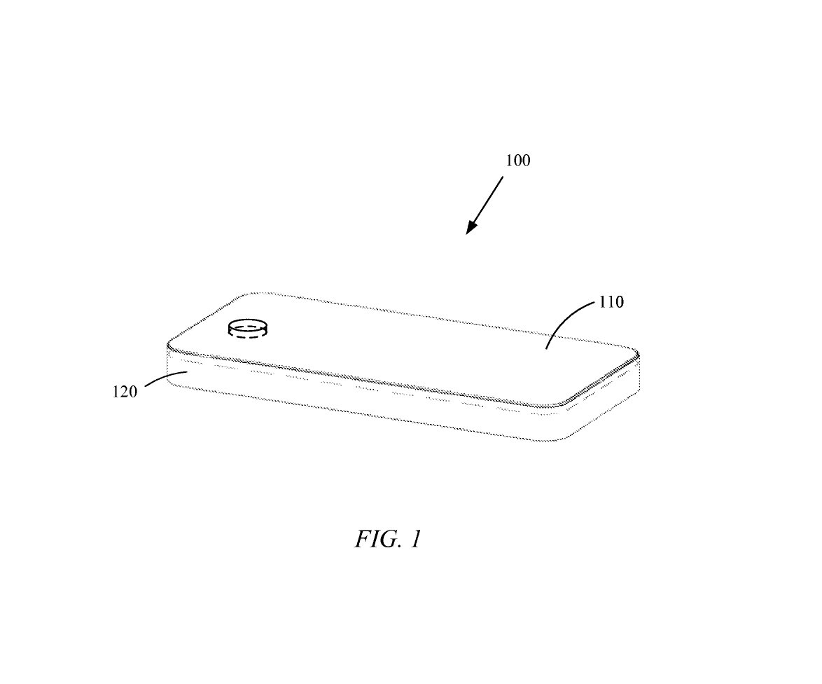

These and other embodiments are discussed below with reference to FIGS. 1-17. However, those skilled in the art will readily appreciate that the detailed description given herein with respect to these Figures is for explanatory purposes only and should not be construed as limiting. Also, for purposes of illustration, some embodiments may not be drawn to scale and some features may be exaggerated in size.

FIG. 1 illustrates an electronic device 100, or simply device 100, having first element 110 adhesively attached to second element 120. In some embodiments, device 100 is a mobile communications device or a smartphone, such as an iPhone® from Apple, Inc., of Cupertino, Calif. In other embodiments, device 100 is a tablet computing device, such as an iPad® from Apple, Inc., of Cupertino, Calif. Also, in some embodiments, first element 110 is a cover glass through which a visual content from device 100 is displayed. In some embodiments, second element 120 is an enclosure that includes several internal components (e.g., central processing unit, microphone). First element 110 may be adhesively attached with second element 120 using the methods and embodiments described below.

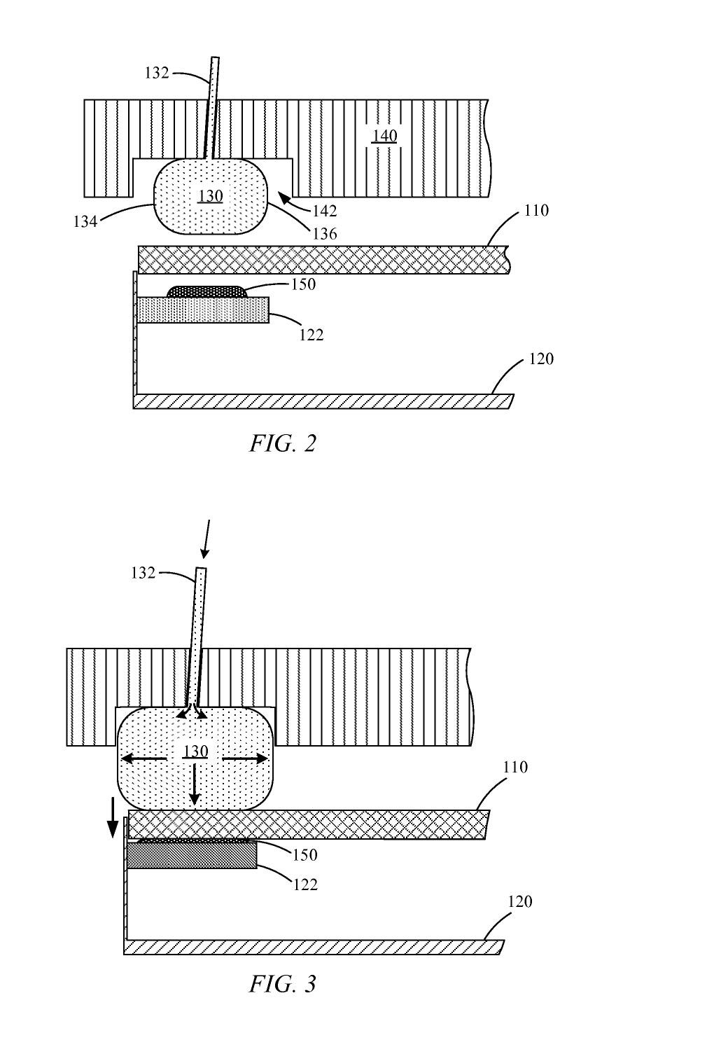

FIGS. 2 and 3 illustrate cross-sectional views an embodiment of an expandable member 130 used to adhesively attach first element 110 with second element 120. In some embodiments, expandable member 130 is made of a silicone material. In other embodiments, expandable member 130 is made of a compliant plastic or polymer material (e.g., heat-resistant silicone for applications where heat is necessary). Still, in other embodiments, expandable member 130 is made from rubber. Also, in some embodiments, expandable member 130 is made from a woven, reinforced material (or materials). Generally, expandable member 130 is an inflatable bladder having a relatively low tensile strength and flexural modulus; that is, expandable member 130 is made from a relatively non-stiff material having a tendency to bend or conform to several complex or non-linear surfaces in which expandable member 130 engages when internal pressure is applied to expandable member 130. These properties also may make expandable member 130 useful in instances where the element or structure engaging expandable member 130 is fragile or may be easily damaged by contact. Also, expandable member 130 is configured to expand from a first size to a second (larger) size (shown in FIG. 3). The first size and the second size may include a first cross-sectional diameter and a second cross-sectional diameter, respectively.

Referring to FIG. 2, expandable member 130 is generally positioned proximate to an outer portion or edge of first element 110 in order to apply a force to the outer portion. Also, plate 140 further includes cavity 142 configured to align expandable member 130 proximate to the outer portion as well as prevent unwanted lateral movement of expandable member 130. This ensures adhesive layer 150 receives at least a minimal threshold pressure for activating adhesive layer 150. In other embodiments, plate 140 is free of any cavity, and expandable member 130 engages a portion of plate 140. Also, in some embodiments, plate 140 is made of a rigid material (e.g., hard plastic). In the embodiment, shown in FIGS. 2 and 3, plate 140 is made of steel.

In order to inflate or expand expandable member 130, expandable member 130 includes an extension 132 having a valve (not shown) configured to receive a fluid which supplies an internal pressure to inflate expandable member 130. Although extension 132 is shown extending through a portion of plate 140, extension 132 may be positioned on first lateral surface 134 or second lateral surface 136 of expandable member 130. In other embodiments, expandable member 130 simply includes a valve configured to connect to a conduit through which the fluid can pass. The fluid used to inflate expandable member 130 may be a gas (e.g., air), liquid, or combination thereof. Also, in some embodiments, the gas and/or liquid is heated, and adhesive layer 150 is a heat-activated layer or film. In this manner, first element 110 may transfer sufficient heat from expandable member 130 to adhesive layer 150 in order activate adhesive layer 150. In the embodiment shown in FIGS. 2 and 3, adhesive layer 150 is PSA layer. In other embodiments where relative high pressure is required, a pneumatic system is configured to supply a compressed fluid to expandable member 130.

FIG. 2 also shows second element 120 having rib 122 capable of receiving adhesively attaching to first element 110. In some embodiments, adhesive layer 150 is initially positioned on first element 110. In the embodiment shown in FIGS. 2 and 3, adhesive layer 150 is initially positioned on rib 122.

In FIG. 3, expandable member 130 receives a fluid through extension 132 in order to expand or inflate expandable member 130 to a second size. During expansion, expandable member 130 engages first element 110 to apply a force to first element 110 which actuates first element 110 in a direction toward second element 120 and rib 122. As a result, first element 110 applies a pressure to adhesive layer 150 causing adhesive layer to activate and adhesively bond first element 110 with second element 120. One advantage of using the described expandable member 130 is the flexibility with respect to tolerances used during assembly. For example, using a rigid body or fixture requires first element 110 and/or second element 120 to be positioned within relatively tight tolerances, leading to increased manufacturing times. Also, these tight tolerances are required when using the rigid body or fixture so that all portions of adhesive layer 150 receive a minimum threshold pressure. However, because expandable member 130 conforms to surfaces of first element 110, first element 110 and/or second element 120 need not be positioned within the same tolerances as required by the rigid fixture. In other words, first element 110, for example, may be positioned in larger tolerances yet expandable member 130 is still capable of applying pressure (or heat) in a manner which activates the entire adhesive layer 150. This leads to decreased manufacturing times, and in some cases, better adhesive bonding.

Also, in some embodiments, expandable member 130 has a substantially circular cross-sectional area. In the embodiment shown in FIG. 3, expandable member 130 has a substantially rectangular cross section. Generally, expandable member 130 may include a cross section configured to apply sufficient force to an element (e.g., first element 110) such that the element supplies a desired amount of pressure or heat to activate adhesive layer 150. Also, it should be noted that during inflation, the cross-sectional shape of expandable member 130 may change. For example, expandable member 130 having a rectangular cross section may become rounded when expanding.

In order to ensure first element 110 is adhesively secured with second element 120, expandable member 130 may remain engaged with first element 110 for a period of time. During testing, the minimum time for expandable member 130 engaging first element 110 is approximately in the range of 15-30 seconds. Also, when air is used to inflate expandable member 130, results of testing show that the pressure should be approximately in the range of 15-100 pounds per square inch (“PSI”).

In the following embodiments described in this detailed description, it should be noted that the expandable members and the plates may include any of the properties described for expandable member 130 and plate 140, respectively, shown in FIGS. 2 and 3. Also, expandable members may be configured to expand using similar techniques described for expandable member 130 shown in FIGS. 2 and 3.

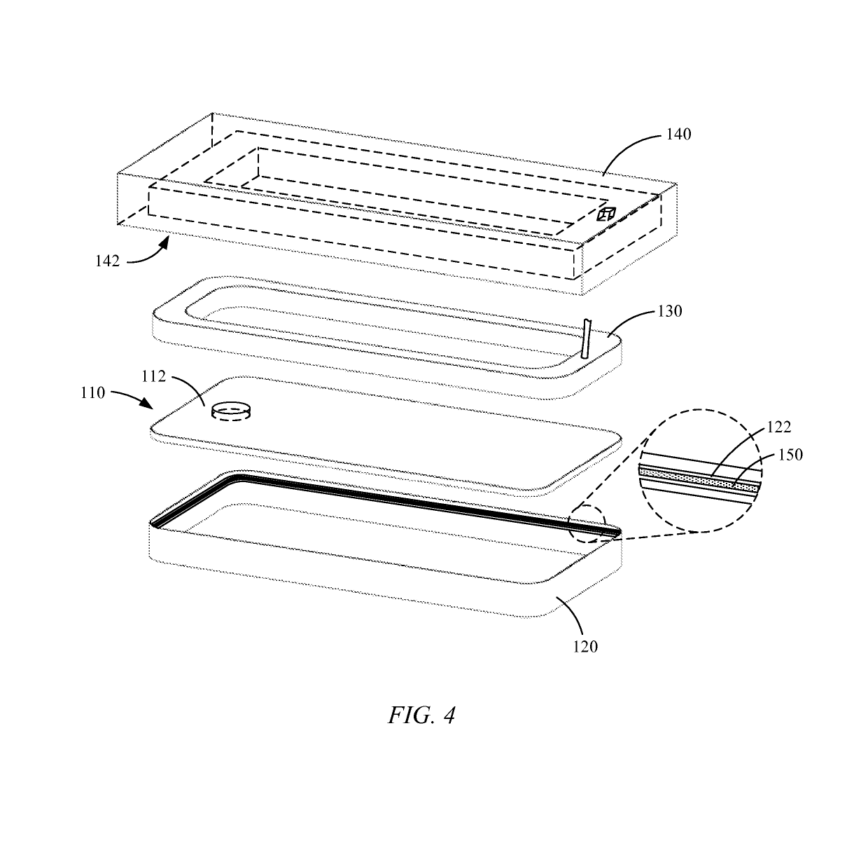

FIG. 4 illustrates an exploded view showing plate 140 and expandable member 130 used to adhesively attach first element 110 with second element 120 in a manner previously described. Cavity 142 is configured to receive expandable member 130 proximate to an outer perimeter of plate 140. Also, expandable member 130 and plate 140 each have an outer perimeter (in terms of dimensions) generally similar to the outer perimeter of first element 110. In this manner, expandable member 130 applies sufficient force to first element 110 on first surface 112 such that a second surface (not shown) opposite first surface 110 engages adhesive layer 150 to apply at least a minimal threshold pressure to activate adhesive layer 150. FIG. 4 also shows a close-up view of adhesive layer 150 positioned on rib 122. Although not shown, rib 122 extends around an entire inner portion of second element 120, and adhesive layer 150 extends around an entire top portion of rib 122. In other embodiments, adhesive layer 150 does not extend around the entire portion of rib 122 but is still sufficient to adhesively bond first element 110 with second element 120.

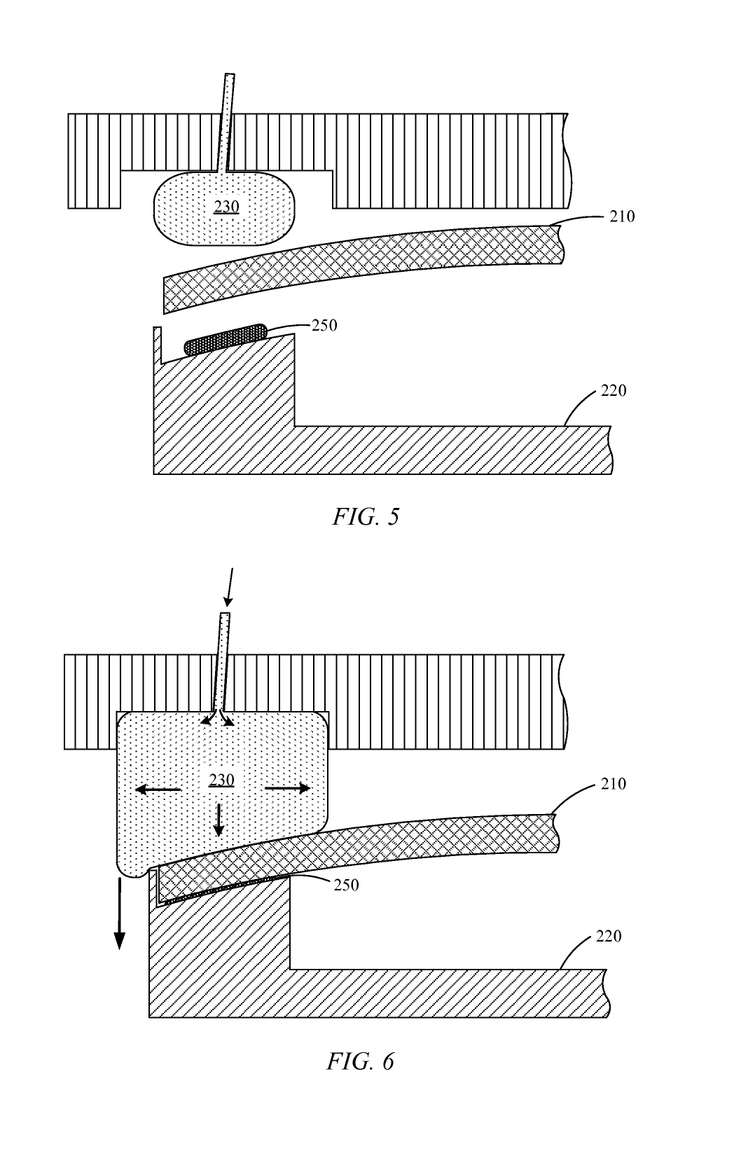

The expandable member is also capable of actuating a curved structure in a manner that applies at least a minimal threshold pressure to the curved structure in order to adhesively attach the curved structure with another structure. FIGS. 5 and 6 illustrate cross-sectional views of an embodiment of an expandable member 230 used to adhesively attach first element 210 having a non-linear portion with second element 220. By inflating expandable member 230 in a manner previously described, the material makeup of expandable member 230 allows expandable member 230 to conform to the curved surface, as shown in FIG. 6. In this manner, expandable member 230 applies a force to first element 210 such that first element 210 may supply at least a minimum threshold pressure to the entire adhesive layer 250. Also, although not shown, first element 210 includes wavelike surface that may be received by expandable member 230 when expandable member 230 is inflated.

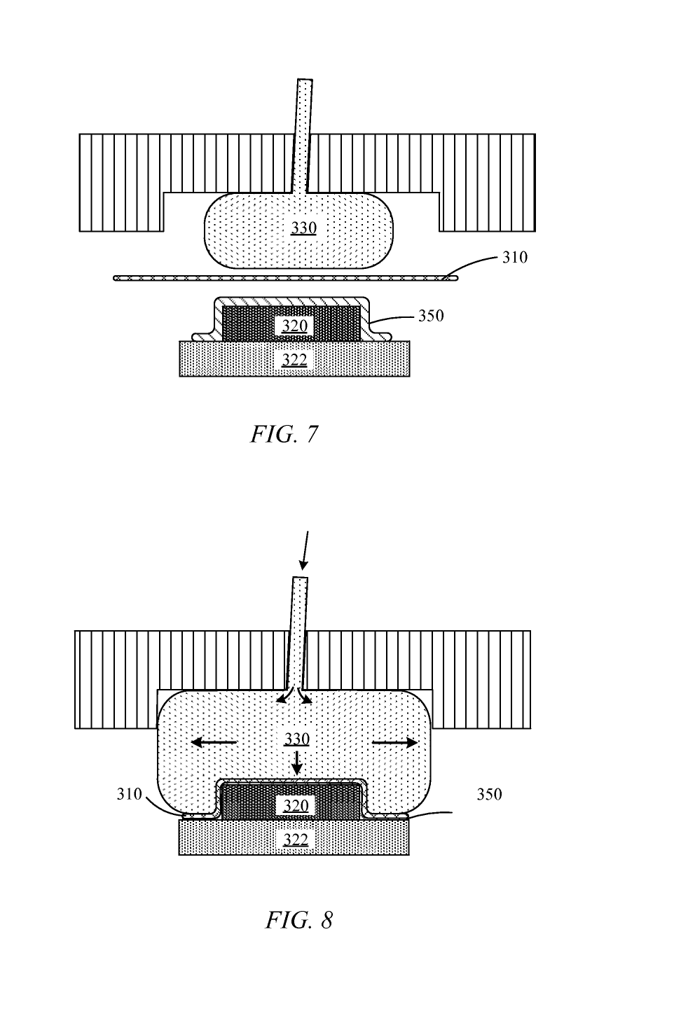

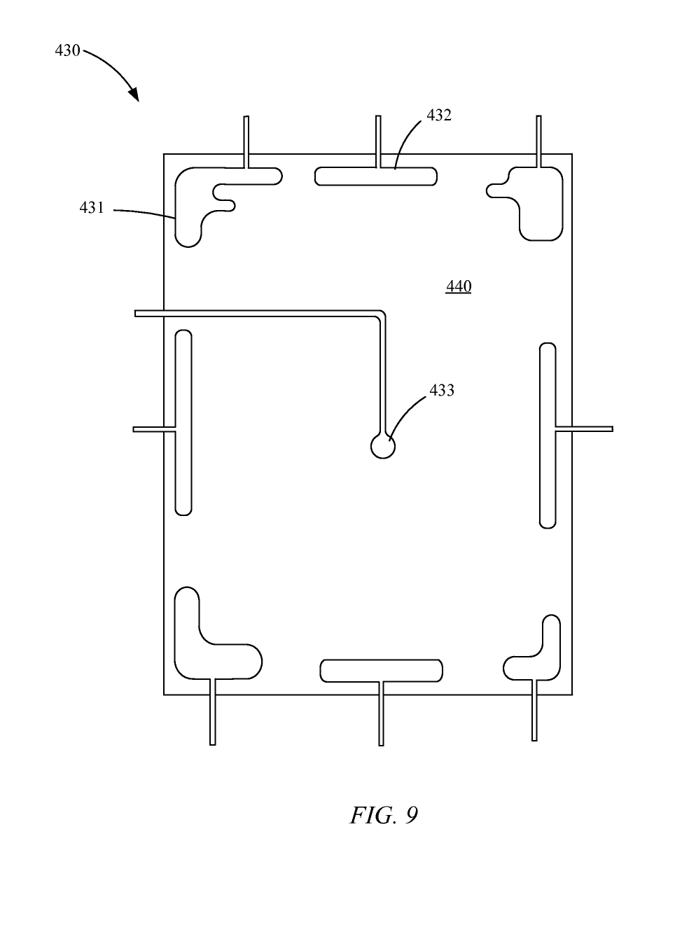

In addition to curved surfaces, an expandable member may be configured to apply pressure to a flexible member in order to adhesively secure the flexible member with another element. For example, FIGS. 7 and 8 illustrate cross-sectional views of an embodiment of an expandable member 330 used to adhesively attach first element 310 with second element 320 as well as third element 322 positioned below second element 320. In some embodiments, third element 322 is part of an enclosure of an electronic device. In some embodiments, first element 310 is a structure configured to bend along an outer peripheral portion of second element 320 and third element 322. In the embodiment shown in FIGS. 7 and 8, first element 310 is silicone layer configured to provide mechanical and/or electrical insulation from external elements. As shown in FIG. 8, by simply inflating expandable member 330, expandable member 330 is configured to conform to the edges of second element 320 as well as an edge defined by an area in which second element is engaged with third element 322, while also applying at least a minimum threshold pressure to adhesive layer 350. Also, expandable member 330 applies sufficient pressure to first element 310 such that first element conforms to the edges of second element 320 as well as an edge defined by an area in which second element is engaged with third element 322. This is advantageous over other method with rigid bodies which could not contact multiple structures with combined different elevations.

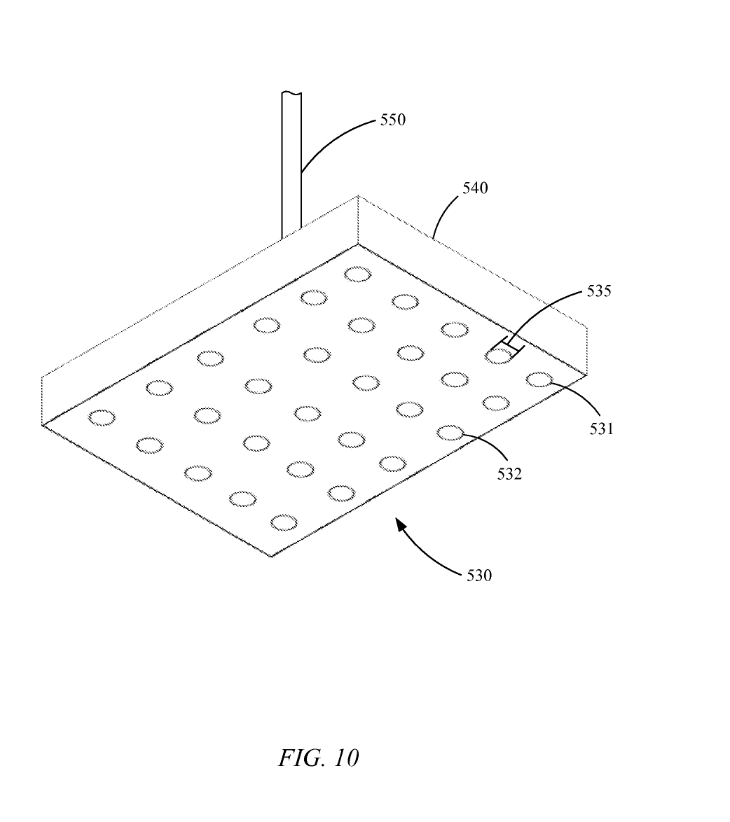

The expandable member, as shown in previous embodiments, is generally a unitary body such that when injecting the expandable member with a fluid, the entire expandable member inflates. However, it may be useful to inflate an expandable member in certain portions to actuate corresponding portions of an element to be adhesively attached. FIGS. 9 and 10 illustrate a bottom view of an embodiment of a plate having several expandable members which may be used to selectively (independently) apply different pressures through individual expandable members. For example, in FIG. 9, plate 440 includes expandable members 430 having a first expandable member 431 and a second expandable member 432. In some embodiments, first expandable member 431 is configured to receive a first pressure and apply a first force to a first portion of an element, while second expandable member 432 is configured to receive a second pressure different from the first pressure, and apply a second force to a second portion of the element, the second force different from the first force. In some instances, the second portion may be made of a more rigid material than the first portion, and accordingly may require additional pressure. In other instances, the second portion may be a critical area in which there should be assurance that the second portion is adhesively secured with another element.

It should be understood that applying a pressure to an expandable member may correspond to the expandable member actuating the element a distance. Accordingly, different pressures may correspond to different distances. For example, in the previous example, first expandable member 431 may actuate a first element a first distance, and second expandable member 432 may actuate the first element a second distance different from the first distance. The second distance may be more or less than the first distance, depending on the desired positioning of the first element. Also, the pressure received by an expandable member may be proportional to the distance an element is actuated by the expandable member.

As shown in FIG. 9, expandable members 430 may take on one of several unique shapes in order to ensure an element receives adequate pressure certain portions. Also, expandable members 430 include third expandable member 433 configured to apply pressure to a central portion of an element in order to adhesively attach the central portion to another element. Also, as shown in FIG. 9, expandable members 430 include ten expandable members on plate 440. In other embodiments, expandable members 430 include nine or less expandable members. Still, in other embodiments, expandable members 430 include at least eleven expandable members. In other embodiments, expandable member 430 may include a plumbing configuration such that applying a fluid to expandable members 430 inflates all of the expandable members 430 in a similar manner.

FIG. 10 illustrates a bottom isometric view plate 540 having expandable members 530 which may be selectively (independently) inflated. For example, first expandable member 531 may be inflated to a first pressure and second expandable member 532 may be inflated to a second pressure different from the first pressure. Plate 540 may be connected to column 550 through which a fluid previously described may inflate expandable members 530. This may useful in applications where different pressures are needed, or to avoid contacting certain portions of an element. In some embodiments, each of the expandable members 530 includes a diameter 535 approximately in the range of 0.5 mm to 2 cm. Also, although expandable member 530 include a generally round shape, in other embodiments, expandable member 530 may include a different shape (e.g., rectangular) configured to provide a desired force on an element. Also, the expandable member 530 is approximately evenly spaced in rows and columns. In other embodiment, expandable members 530 are unevenly spaced in order to engage certain portions of an element to be adhesively attached.

Alternatively, the embodiments shown in FIGS. 9 and 10 may be useful in rework applications. For example, in FIG. 10, if a portion of an element corresponding to first expandable member 531 was not adhesively secured with another element, it may be desirable to re-apply the same amount of pressure, or a greater pressure, only to first expandable member 531 so that other portions which were previously attached in a proper manner are not disturbed.

In previous embodiments, the expandable member is used to apply pressure directly to an element to be adhesively attached. However, it may be advantageous to engage elements with another member positioned between the expandable member and an element to be adhesively attached. For example, an elastic member made of a material (or materials) different than that of the expandable manner may be used. This may, for example, prevent damage to the element which may be an external feature having a fragile surface. Also, it may be advantageous to apply pressure to a larger surface area of an element to be adhesively attached, which in turn can activate an adhesive layer having a larger surface area. Further, the elastic member may be replaced by a different elastic member either to replace a damaged elastic member or to protect an expandable member. Also, different elastic members may include different dimensions used to assemble, for example, electronic devices of varying dimensions.

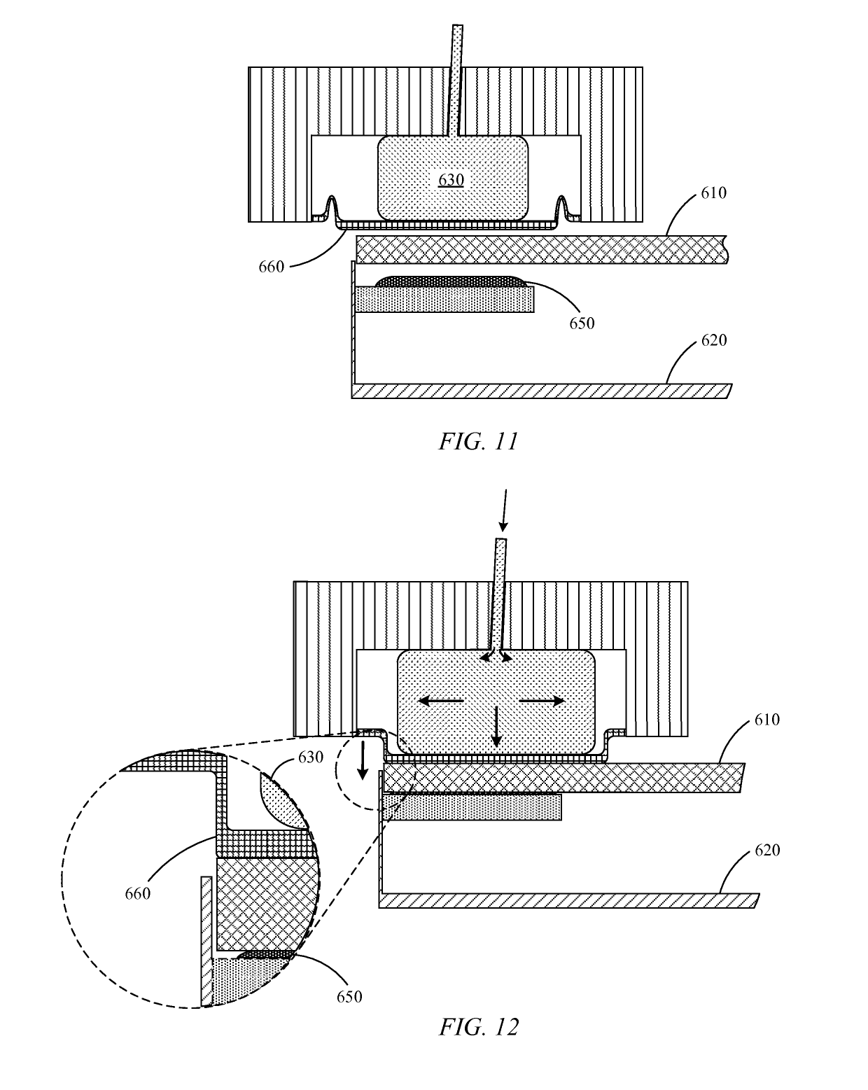

FIGS. 11 and 12 illustrate a cross-sectional an embodiment of an expandable member 630 engaging elastic member 660 configured to engage first element 610 in order to adhesively attach first element 610 with second element 620. Elastic member 660 is generally a semi-rigid member configured to actuate when expandable member 630 applies pressure to elastic member 660. In some embodiments, elastic member 660 is made of a silicone material. Elastic member 660 may be connected to a lower portion of plate 640 and is engaged with a lower portion expandable member 630. Also, in some embodiments, expandable member 660 extends around the cavity such that expandable member 630 does not directly contact first element 610. As shown in FIG. 12, as expandable member 630 inflates, expandable member 630 actuates elastic member 660 to engage first element 610, and subsequently actuates first element 610 such that first element 610 applies a force to adhesive layer 650 in order to adhesively attach first element 610 with second element 620. As shown in the close-up view in FIG. 12, although expandable member 630 is not fully positioned over adhesive layer 650, elastic member 660 is fully positioned over adhesive layer 650. As a result, it is assured that adhesive layer 650 receives the minimum threshold pressure to activate. It will be appreciated that expandable member 630 and elastic member 660 may be configured to adhesively attach element described in previously embodiments (e.g., first element 210 in FIGS. 5 and 6).

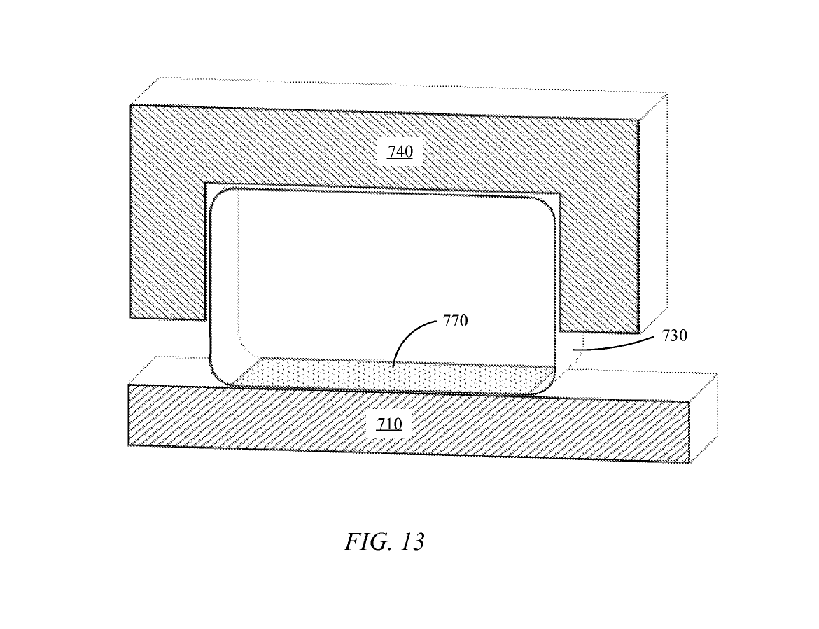

In order to ensure a sufficient force, or in some cases excessive force, is being applied to an element, a test may be performed to determine force. FIG. 13 illustrates an isometric view of a portion of plate 740 enclosing a portion of expandable member 730 inflated and engaged with first element 710. Area 770 refers to a two-dimensional surface area in which expandable member 730 contacts first element 710. Using the equation, Pressure =Force X Area, the force applied to first element 710 may be calculated. Area 770 may be measured, or may be determined based on the dimensions of expandable member 730. Because expandable member 730 generally has a negligent stiffness, the internal pressure within expandable member 730 is substantially similar to the external pressure expandable member 730 applies to first element 710. Once area 770 and pressure are known, the force can be calculated using the above equation by dividing the pressure by area 770.

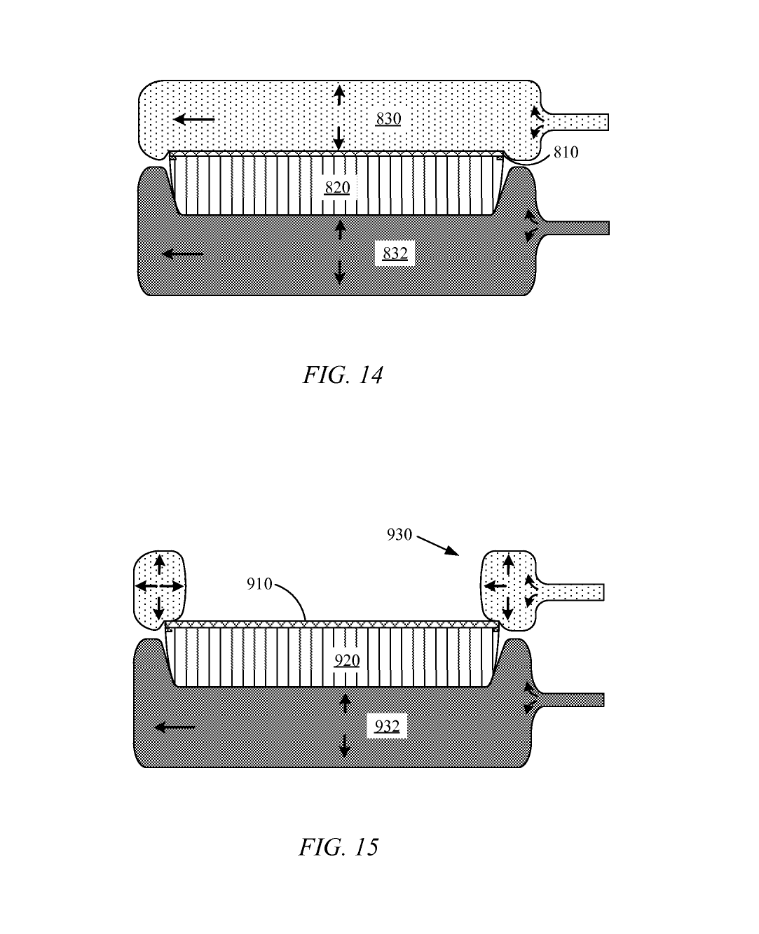

FIGS. 14 and 15 illustrate embodiments of an assembly process using a first expandable member positioned on a first element and a second expandable member positioned on a second element. One advantage includes easy adjustment/alignment to first element and/or second element. Also, because both the first expandable member and/or the second expandable member can be inflated, another advantage includes using the same first expandable member and second expandable member for different electronic devices having different shapes and sizes. A plate (not shown) similar to plates previously described may be used with the first expandable member and/or the second expandable member. Similar to previous embodiments, the first expandable member is configured to apply a first force to actuate the first element in a first direction. As shown in FIGS. 14 and 15, the second expandable member is configured to apply a force to the second element such that the second element extends in a second direction opposite the first direction. In other words, first expandable member 830 actuates first element 810 in a direction toward second element 820 and second expandable member 832 actuates second element 820 in a direction toward first element 810. Also, an adhesive layer (not shown) is used to adhesively attach the first element with the second element. The adhesive layer includes any properties previously described for an adhesive layer. It will be appreciated that the first element and the second element are not assembled prior to expanding the expandable members shown in FIGS. 14 and 15.

FIG. 14 illustrates a cross-sectional view of an assembly process including first expandable member 830 inflated and engaged with first element 810, and second expandable member 832 engaged with second element 820. Exemplary applications include instances where the adhesive layer is a film or sheet covering an entire surface of first element 810 such that the entire surface of first element 810 is adhesively attached to an entire surface of second element 820. Also, first expandable member 830 and second expandable member 832, collectively, may supply additional pressure in order to activate an adhesive layer having a relatively high minimum threshold pressure for activation, or in cases where first element 810 and/or second element are made of relatively rigid materials.

FIG. 15 illustrates a cross-sectional view of an assembly process including first expandable member 930 engaged with first element 910, and second expandable member 932 engaged with second element 920. In this embodiment, first expandable member 930 is a ring or annulus (similar to expandable member 130 shown in FIG. 4). This may be used in cases where it is unnecessary or harmful to engage a central portion of first element 910.

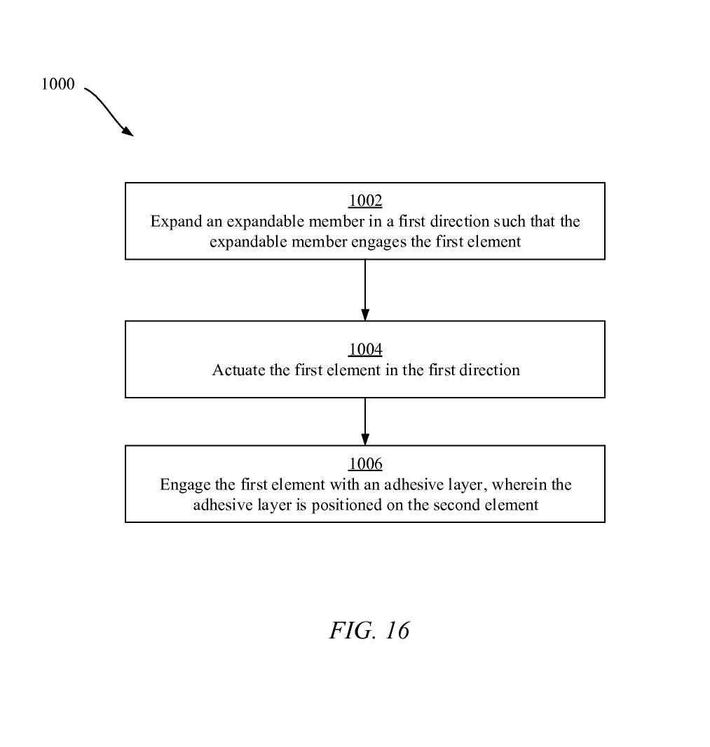

FIG. 16 illustrates a flowchart 1000 describing a method for adhesively attaching a first element with a second element. In step 1002, an expandable member is expanded in a first direction to engage the first element. In some embodiments, the expandable member is an inflatable membrane made from a material selected from a compliant plastic or polymer, rubber, or a woven, reinforced material. Also, in some embodiments, the expandable member is expanded by adding a fluid (e.g., gas, liquid), and in addition, the fluid may be heated. Also, in some embodiments, the first element is a cover glass of an electronic device. In other embodiments, the first element is an element having a complex or non-linear structure.

In step 1004, the first element is actuated in the first direction. In step 1006, engaging the first element with an adhesive layer, wherein the adhesive layer is positioned on the second element. In some embodiments, the second element is an enclosure of an electronic device. In some embodiments, the adhesive is an adhesive layer positioned on a rib of a second element. In some embodiments, the adhesive is a pressure sensitive adhesive. In other embodiments, the adhesive is a heat-activated adhesive.

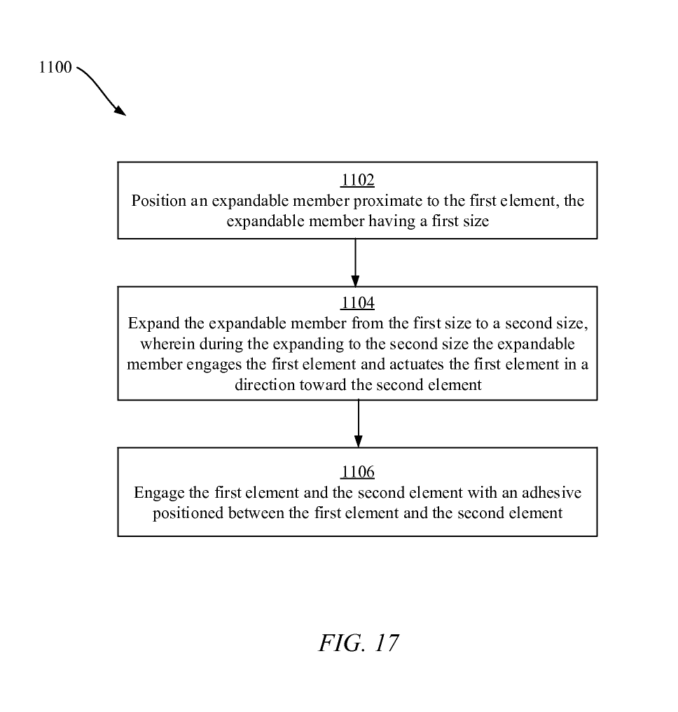

FIG. 17 illustrates a flowchart 1100 describing a method for adhesively attaching a first element with a second element, the first element and the second element part of an electronic device. In step 1102, an expandable member is positioned proximate to the first element, the expandable member having a first size. In step 1104, the expandable member is expanded from the first size to a second size, wherein during the expanding to the second size the expandable member engages the first element and actuates the first element in a direction toward the second element. In step 1106, the first element and the second element engage an adhesive positioned between the first element and the second element.

Also, an expandable member may be suitable for adhesively attaching components within an electronic device, particularly when the component and/or an internal portion of the electronic device include a complex or non-linear shape. For example, an internal power supply (e.g., battery) may be adhesively attached to the internal portion of the electronic device by applying a force to the internal power supply from the expandable member.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A method for adhesively attaching a first element with a second element, the method comprising:
expanding an expandable member in a first direction such that the expandable member engages the first element;
actuating the first element in the first direction; and
engaging the first element with an adhesive layer, wherein the adhesive layer is positioned on the second element.

2. The method as recited in claim 1, wherein the adhesive layer is a pressure sensitive adhesive (PSA).

3. The method as recited in claim 2, wherein engaging the first element with the PSA includes activating the PSA.

4. The method as recited in claim 3, wherein the first element includes a non-linear surface.

5. The method as recited in claim 4, wherein the expandable member is configured to engage the non-linear surface and apply a minimum threshold pressure to the non-linear surface such that all portions of the PSA are activated.

6. The method as recited in claim 1, wherein the first element is a cover glass of an electronic device, and wherein the second element is an enclosure of the electronic device.

7. The method as recited in claim 1, wherein expanding the expandable member includes inflating the expandable member with a fluid.

8. The method as recited in claim 1, wherein the expandable member is made from rubber.

9. The method as recited in claim 1, further comprising:
expanding the expandable member to a first pressure to apply a first force on the first element; and
expanding a second expandable member in the first direction such that the expandable member engages the first element and actuates the first element in the first direction, wherein the second expandable member is expanded to a second pressure different from the first pressure, the second expandable member applying a second force on the first element different from the first force.

10. The method as recited in claim 1, further comprising expanding a second expandable member in a second direction such that the second expandable member engages the second element and actuates the second element in the second direction, the second direction opposite the first direction.

11. A system for actuating a first element proximate to a second element in order to adhesively attach the first element with the second element, the system comprising:
a plate having a cavity;
an expandable member positioned within a portion of the cavity, the expandable member capable of expanding from first size to a second size, wherein when the expandable member extends in a direction away from the plate when expanding from the first size to the second size; and
wherein an adhesive layer bonds with the first element and the second element when the expandable member inflates to the second size.

12. The system as recited in claim 11, further comprising an elastic member connected to a lower portion of the plate, the elastic member configured to engage the first element.

13. The system as recited in claim 11, wherein the expandable member is an annulus that extends around an outer portion of a first surface of the first element, and wherein the adhesive layer is positioned on a rib extending around an inner portion of the second element.

14. The system as recited in claim 11, wherein the expandable member covers an entire first surface of the first element, and wherein the adhesive layer covers an entire second surface of the first element, the second surface opposite the first surface.

15. The system as recited in claim 11, wherein the adhesive layer bonds the first element with a third element, the third element contacting a portion of the second element.

16. A method for adhesively attaching a first element with a second element, the first element and the second element combine to form a portion of an electronic device, the method comprising:
positioning an expandable member proximate to the first element, the expandable member having a first size;
expanding the expandable member from the first size to a second size greater than the first size, wherein during the expanding to the second size the expandable member engages the first element and actuates the first element in a direction toward the second element;
positioning an adhesive layer within the second element; and
engaging the first element with the adhesive layer positioned between the first element and the second element.

17. The method as recited in claim 16, wherein the first element is a first component positioned within the electronic device, and wherein the second element is a second component having a surface that receives the first component.

18. The method as recited in claim 16, wherein engaging the first element with the adhesive layer provides at least a minimum threshold pressure configured to activate the adhesive layer to bond the first element with the second element.

19. The method as recited in claim 16, further comprising engaging the expandable member with a plate.

20. The method as recited in claim 19, wherein the plate includes a second expandable member expanding to a second size different from the second size of the expandable member, wherein the second expandable receives a pressure different from a pressure received by the expandable member.
